(19) United States
(12) Patent Application Publication
(10) Pub. No.: US 2023/0030542 A1
(43) Pub. Date: Feb. 2, 2023

(54) SYSTEM AND ASSOCIATED METHODS FOR THIRD-PARTY MANAGEMENT OF PROMOTIONS BASED ON WAREHOUSE INVENTORY

(71) Applicant: FLEXE, INC., Seattle, WA (US)

(72) Inventors: Karl Siebrecht, Seattle, WA (US); Megan M. Quintero, Redwood City, CA (US); David Glick, Seattle, WA (US)

(21) Appl. No.: 17/382,778

(22) Filed: Jul. 22, 2021

(51) Int. Cl. G06Q 30/02; G06Q 10/08; G06Q 30/06

(52) U.S. Cl. CPC G06Q 30/0254; G06Q 10/087; G06Q 30/0257; G06Q 30/0283; G06Q 30/0633

(57) ABSTRACT

A system and associated methods for managing digital advertising promotions on behalf of merchants, in response to changes in the availability of promoted items, are provided. In some embodiments, the method includes receiving purchase data from an electronic shopping cart associated with a merchant, based on which a rate of sale of a purchased item is generated. The method includes accessing a database storing a plurality of node data set, each node data set being associated with a warehouse node. Based on the node data sets and the rate of sale, the method additionally includes determining a projected availability of the purchased item in a delivery region. The method also includes adjusting, based on the projected availability, a digital promotion advertising at least the purchased item.

### BACKGROUND

Merchants frequently operate digital advertising campaigns designed to encourage customers to purchase their goods. For example, an advertising campaign may promote an item or class of items, and offer incentives such as free next day shipping, discounted purchase prices, reduced-cost shipping options, etc. In some instances advertising campaigns are targeted to a particular class of items, within a certain geographic region, for only a limited window of time. However, for merchants that do not have their own warehouse facilities, it can be difficult to determine the extent to which such targeted advertisements remain sustainable in view of the merchants' inventory of the promoted items. Similarly, for merchants that do not have their own warehouse facilities, it can be challenging for the merchants to recognize when excess inventory can enable opportunities for new or expanded promotions. It would therefore be beneficial to provide improved systems and methods for managing advertising promotions based on available warehouse inventory, particularly in situations where the merchant does not have direct knowledge of inventory levels.

### BRIEF DESCRIPTION OF THE DRAWINGS

FIG. 1 is a schematic illustration of an exemplary supply chain for movement of inventory from warehouse nodes to customers.

FIG. 2 is a network diagram illustrating an exemplary computing environment in which a promotion management system operates.

FIG. 3A is a schematic illustration of an exemplary data structure for storing warehouse node information.

FIG. 3B is a schematic illustration of an exemplary data structure for storing carrier information.

FIG. 3C is a schematic illustration of an exemplary data structure for storing promotion information.

FIG. 4 is a flow diagram illustrating an exemplary process implemented by a promotion management system for adjusting a promotion offered by a merchant based on inventory of a promoted item.

FIG. 5 is a schematic illustration of an exemplary search result, with advertisements, for a promoted item.

The techniques introduced in this disclosure can be better understood by referring to the following Detailed Description in conjunction with the accompanying drawings.

### DETAILED DESCRIPTION

A promotion management system that adjusts digital advertisements designed to promote the sale of items based on the availability of those items and related factors, and associated methods are disclosed herein. As described herein, the adjustments made by the promotion management system can encompass generating new digital advertising promotions or expanding existing digital advertising promotions when the inventory availability of a good and the costs involved with storing and shipping the good makes a promotion beneficial. The promotion management system can also curtail or terminate an existing digital advertising promotion based on inventory changes reflecting reduced availability of the good. Furthermore, advertising promotions may be adjusted in a hyperlocal fashion, in that the promotion management system can adjust advertising promotions differently depending on the inventory (and related factors) of a product within a particular region.

In some embodiments, the system receives purchase data characterizing the purchase of items being promoted by a merchant. The purchase data can be received, for example, from the merchant itself, from an electronic shopping cart service associated with the merchant, and/or from a third-party associated with the merchant, and includes data about the purchase transaction such as the items sold, the quantity of items sold, the geographical region to which the purchased items are to be delivered, and profile or segment data characterizing the purchasing customer. Based on the purchase data, as well as data regarding available inventory of the promoted items in different geographic regions, the system determines a projected (e.g., future) availability of the promoted items and modifies a corresponding promotion accordingly. For example, the system can initiate a new advertising promotion, can adjust certain parameters of an existing promotion (e.g., an advertised shipping speed, advertised shipping cost, etc.) to expand or curtail the promotion, or can end a promotion (e.g., no longer advertise the promoted item) depending on the projected availability. In some embodiments the merchant's inventory of the promoted items is not stored in warehouses owned, maintained, or over which the merchant has direct control. Rather, in some embodiments, the merchant's inventory of the promoted items is stored in warehouses, some of which also store the inventory of other merchants, that are managed by an inventory apportioning service.

Various implementations of the system and methods will now be described. The following description provides specific details for a thorough understanding and an enabling description of these implementations. One skilled in the art will understand, however, that the system and methods may be practiced without many of these details or with alternative approaches. Additionally, some well-known structures or functions may not be shown or described in detail so as to avoid unnecessarily obscuring the relevant description of the various implementations. The terminology used in the description presented below is intended to be interpreted in its broadest reasonable manner, even though it is being used in conjunction with a detailed description of certain specific implementations of the system and methods.

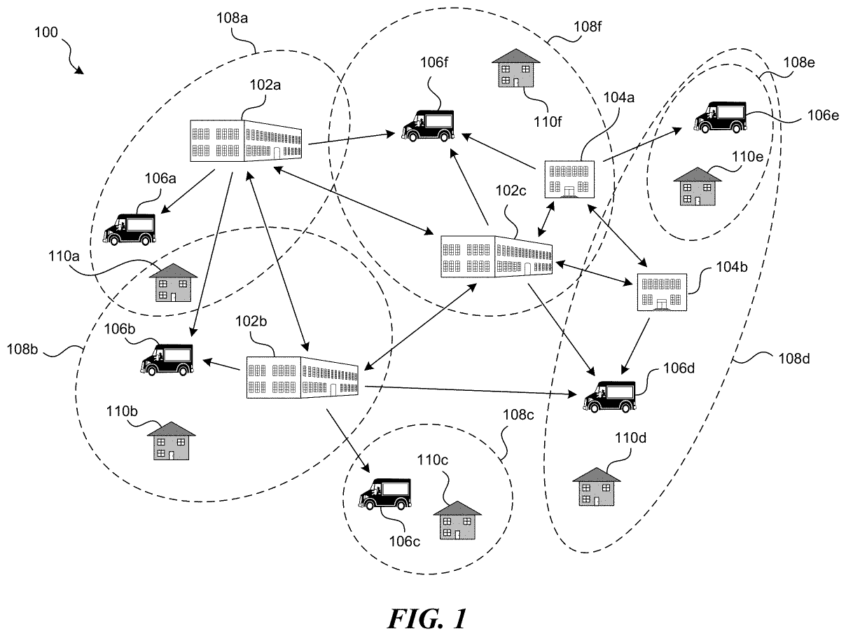

FIG. 1 is a schematic illustration of an exemplary supply chain 100 for movement of inventory from warehouse nodes to customers. The supply chain 100 includes a plurality of warehouse nodes 102a-c (e.g., fulfillment centers (FCs), distribution centers (DCs)) that receive and store inventory from a plurality of different merchants (not shown). The transfer of inventory from a merchant to a warehouse node may be referred to herein as an “inbound” transfer. The warehouse nodes 102a-c can be geographically distributed such that each warehouse node is located in a different geographic region (e.g., different neighborhood, city/town, county, area code, state, region, country, etc.). A warehouse node can operate as a single independent facility (e.g., warehouse nodes 102a-n), or can operate according to a hub-and-spoke model (e.g., warehouse node 102c serves as a centralized “hub” for receiving and routing inventory to satellite “spoke” warehouse nodes 104a-n). Inventory can be transferred between warehouse nodes 102a-n, between hub warehouse node 102c and its spoke warehouse nodes 104a-n, and/or between spoke warehouse nodes 104a-n.

The supply chain 100 includes a large number of warehouse nodes, such as hundreds or thousands of warehouse nodes. The operator of the promotion management system described herein does not own, lease, operate, or otherwise directly control any of the warehouse nodes. Instead, the warehouse nodes are owned and operated by third party warehouse operators. Different warehouse nodes may be owned and operated by different warehouse operators. For example, warehouse nodes 102a-c may be owned and operated by one, two, or three operators. Different warehouse operators may have different procedures for receiving, storing, and shipping inventory, and may use different software and hardware systems to operate their warehouse nodes. As such, merchants utilizing the warehouse nodes for the shipment of their own goods face a daunting coordination and management challenge. As described in greater detail below, the promotion management system provides a unified technology platform for interfacing with inventory data from large numbers of third party-operated warehouse nodes, thus allowing merchants to conveniently and dynamically leverage the capabilities of the full warehouse node network for inventory storage, while at the same time utilizing individual or aggregate inventory data to better manage ongoing advertising campaigns.

The supply chain 100 includes a plurality of carriers 106a-f that receive and deliver inventory stored in the warehouse nodes to a plurality of different delivery regions 108a-f and customers 110a-f. The transfer of inventory from a warehouse node to a customer may be referred to herein as an “outbound” transfer. Each carrier provides shipping services to a respective delivery region utilizing a certain shipping speed and with certain shipping costs, e.g., carrier 106a ships to delivery region 108a with delivery to customers within a certain time frame A at a cost X, carrier 106b ships to delivery region 108b with delivery to customers within a certain time frame B at a cost Y, etc. The size and/or location of the delivery region can vary from carrier to carrier such that different carriers provide shipping services to different geographic regions, each having certain shipping speeds and with different costs associated with those carriers and shipping speeds. Some carriers can serve delivery regions identical or similar to the delivery regions served by other carriers, with the same or different shipping speeds and/or costs for each of those regions. There can be some degree of overlap between delivery regions (e.g., delivery region 108a partially overlaps delivery region 108b). Conversely, some delivery regions may not overlap with any other delivery region (e.g., delivery region 108c). Optionally, a larger delivery region served by a carrier can completely encompass a smaller delivery region served by another carrier (e.g., delivery region 108d encompasses delivery region 108e). For purposes of this description, a shipping speed associated with a carrier indicates that the carrier has a high statistical likelihood (e.g., at least a 75%, 90%, 95%, or 99% likelihood) of being able to deliver to a particular location within the corresponding timeframe (e.g., same day, next day, next business day, or same week).

The delivery regions 108a-f include the plurality of customers 110a-f that can purchase inventory from the merchants. The customers 110a-f can purchase a merchant's inventory through a variety of different sales channels. A merchant's products may be purchased, for example, at a physical location maintained by the merchant, at a physical channel operated by a merchant partner, by calling a merchant phone number, through a website or application that offers a merchant's products, etc. Purchases made at a merchant website may be conducted using an electronic shopping cart, which may be provided by a third-party shopping cart partner of the merchant. Certain customers 110a-f may have been encouraged to purchase inventory by digital advertisements promoting the inventory, while other customers may be repeat purchasers of the merchant's products.

After purchase, products are delivered to customers via different delivery services. The customers 110a-f are geographically distributed among the delivery regions 108a-f such that different customers are served by different carriers. A customer located in multiple delivery regions can receive shipments from multiple carriers, e.g., customer 110a is located in delivery regions 108a-b and can receive shipments from carriers 106a-b. Carriers 106a and 106b may offer delivery to customer 110a within a similar time frame, e.g., within 2 days. Or carriers 106a and 106b may offer delivery to customer 110a within different time frames. For example, carrier 106a may be able to deliver to customer 110a within 1 day of receipt of order, whereas carrier 106b may be able to deliver to customer 110a within 2 days of receipt of order. A customer located in a single delivery region can receive shipments from a single carrier, e.g., customer 110c is located in a single delivery region 108c and receives shipments only from carrier 106c.

In the supply chain 100, each warehouse node is served only by certain carriers. For example, warehouse node 102a is served by carriers 106a, 106b, and 106f; warehouse node 102b is served by carriers 106b, 106c, and 106d; warehouse node 102c is served by carriers 106d and 106f; spoke warehouse node 104a is served by carriers 106e and 106f; and spoke warehouse node 104b is served by carrier 106d. As a result, a warehouse node can ship inventory only to customers located in the delivery regions served by its carrier(s). For example, warehouse node 102a can ship inventory to customers 110a-b and 110f; but not to customers 110c-e.

In the supply chain 100, each warehouse node may receive and store inventory of more than one merchant. The manner in which the inventory of multiple merchants is apportioned to multiple warehouse nodes may be determined by a warehouse apportioning system. The warehouse apportioning system may further determine which warehouse node and carrier will be used to supply and deliver a merchant's item to a customer. In other words, in some embodiments of the supply chain 100, merchants do not directly control where their inventory is stored or how purchased inventory is delivered to a customer. An exemplary warehouse apportioning system is described in U.S. patent application Ser. No. 16/983,868, filed on Aug. 3, 2020 and titled “SYSTEM AND ASSOCIATED METHODS FOR APPORTIONMENT OF INVENTORY BETWEEN WAREHOUSE NODES TO ACHIEVE REQUESTED SERVICE LEVELS,” the entirety of which is incorporated herein by reference.

A merchant may use digital advertisements to encourage customers to purchase certain items or classes of items from the merchant's inventory. For example, advertisements may be placed in online websites, such as search result websites, social media websites, news websites, etc., and may be part of a broader advertising campaign. As another example, advertisements may be placed in applications, such as shopping applications or social media applications. As still another example, advertisements may be targeted at a user's mobile device, such as via SMS or other messages. The digital advertisements, or advertising campaigns, may be in part managed by an advertising partner that serves the advertisements. The merchant may additionally wish to advertise certain promotions in order to further encourage customers to purchase items. For example, as part of a promotion the merchant may advertise free same-day shipping, free next-day shipping, free shipping by the next business day, or other delivery promotions designed to further incentivize customer purchase. In some situations, however, the promotions may be narrowly targeted, in that the promotions are intended to be offered for only a limited time, in a specific region, and for only a certain class of items. For example, one promotion could promote umbrellas in a region experiencing unusually heavy rainfalls, where the promotion is to end once the weather returns to normal. As a further example, one promotion could promote seasonal gifts during a particular holiday season. Because such promotions are intended to be narrowly targeted, it is important that the promotion be responsive to the merchant's ability to meet customer demand. As a result of merchants utilizing warehouse apportioning systems, however, it can be difficult for merchants to assess how their inventory is being used to fulfill customer purchases, and how much longer customer demand can be met while a promotion is active, and adjust advertising promotions accordingly. In a particularly damaging scenario, a merchant may continue to advertise products and offer special promotions even though there is little or no available inventory to deliver to customers wanting to purchase the advertised products. In an alternative scenario, the amount of product inventory sitting in a warehouse and the costs associated with maintaining the inventory may make it beneficial to initiate an advertising promotion to incentivize the purchase of certain products, where it is preferable to sell products by incurring the costs of a promotion rather than having the products sit unused.

The system for promotion management described herein can recognize when a merchant's inventory is unlikely to be able to continue satisfying customer purchases, or when there are opportunities to promote certain items of a merchant's inventory, and adjust an advertising promotion accordingly. In some embodiments, the promotion management system uses purchase data regarding purchases of a promoted item (e.g., received from the merchant or from an electronic shopping cart used by the merchant) to determine a rate of sale for the item (i.e., how many units are being purchased over a unit of time). Using the rate of sale for the item, as well the merchant's inventory of the promoted item, the system determines a projected availability of the item. That is, the system projects the likely future availability of the item (e.g., availability the next day, the next week, etc.) based on the item sales rates. Additionally, the system can determine projected availabilities that are specific to a particular region (e.g., “Los Angeles area,” “California,” “Western United States,” etc.) using purchase data for purchases being delivered to the region and inventory data for warehouse nodes that can deliver to the region. Furthermore, the system can evaluate the costs of maintaining items in inventory as well as shipping costs of those items. As the projected availability of an item changes (e.g., decreases in a region due to sales, increases due to inbound shipments of the item, etc.), the system adjusts advertising promotions for that item. For example, as the projected availability of an item decreases, the system may reduce the reach of a promotion (e.g., the number of digital advertisements) or the extent of the promotion (e.g., shipping guarantees) to begin to slow the future rate of sales of the promoted item. As a further example, the system can initiate or expand an advertising promotion for a particular item in a certain geographical region when it is beneficial to do so. Accordingly, the promotion management system adjusts a merchant's promotion as the merchant's available inventory changes (e.g., begins to taper or increases), without involvement of the merchant, such that a promotion is ended at or around the time that the merchant's inventory runs out. The system described herein is therefore expected to enhance the ability of merchants to engage in targeted promotions that operate for only a short duration of time or in a small geographic region, even when the apportioning of the merchant's inventory among warehouse nodes remains opaque or otherwise unknown to the merchant.

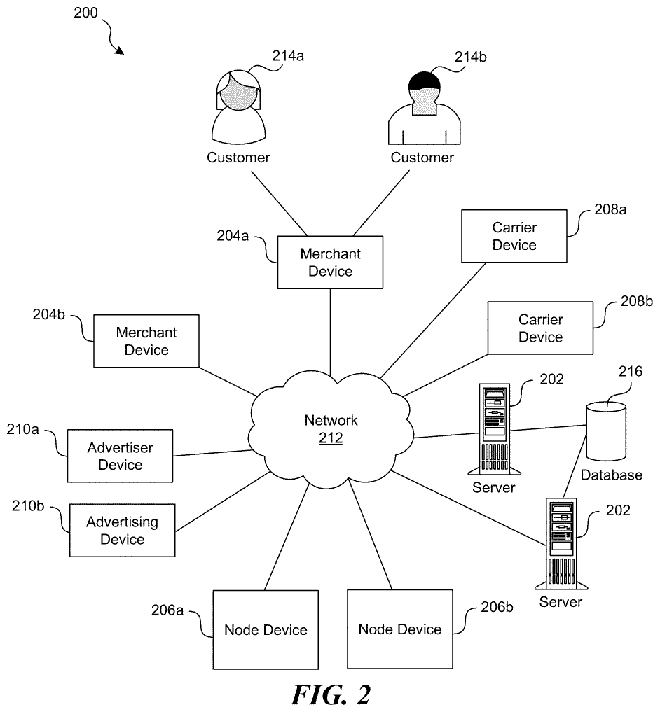

FIG. 2 is a network diagram illustrating an exemplary computing environment 200 in which a promotion management system operates. Although not required, aspects of the system are described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions reside on a client computer.

The environment 200 includes server computers 202 (“servers”), a plurality of merchant devices 204a-n, a plurality of node devices 206a-n, a plurality of carrier devices 208a-n, and a plurality of advertiser devices 210a-n that communicate with each other through a network 212. The network 212 can be a LAN or a WAN, and can include wired or wireless network elements. In some embodiments, the network 212 is the Internet or some other public or private network.

Servers 202 operate a warehouse apportioning system that allows merchants to store products in different warehouses and fulfill product orders from customers from those warehouses. Servers 202 receive inventory placement requests from merchants and determine how inventory should be apportioned between warehouse nodes to fulfill anticipated product demand, based on the warehouse node information and/or carrier information stored in database 216. For purposes of this description, a database is any data structure that allows for the relational or non-relational storage of data, including flat files. In some embodiments, a placement request from a merchant device includes one or more service level parameters (e.g., shipping speed, shipping cost, customer segment, anticipated shipping time frame), and the servers 202 select warehouse nodes that are capable of meeting at least some or all of the service level parameters. Once the apportioning has been determined, the servers 202 can send placement instructions to the merchant device with information on the selected warehouse nodes and the amount of inventory to ship to each warehouse node. Further details about the warehouse apportioning system may be found in the aforementioned U.S. patent application Ser. No. 16/983,868, filed on Aug. 3, 2020 and titled “SYSTEM AND ASSOCIATED METHODS FOR APPORTIONMENT OF INVENTORY BETWEEN WAREHOUSE NODES TO ACHIEVE REQUESTED SERVICE LEVELS.”

The warehouse node devices 206a-n are computing devices operated by or otherwise associated with different warehouse nodes. Each warehouse node device can send information regarding the corresponding warehouse node to the servers 202. Warehouse node information can include, for example, facility information, availability of storage space, pricing, carrier information, performance information, and inventory information. The servers 202 can process and/or store the received warehouse node information in a database 216, as described in greater detail below.

The carrier devices 208a-n are computing devices operated by or otherwise associated with different carriers. In some embodiments, the carrier devices 208a-n communicate with the merchant devices 204a-n and/or the node devices 206a-n (e.g., via network 212) to coordinate shipments of inventory from merchants to warehouse nodes, between warehouse nodes, and/or from warehouse nodes to customers. Optionally, the carrier devices 208a-n can also send information to the servers 202. The carrier information can include, for example, delivery regions served by the carrier, shipping speed, handling options, pricing, time periods when the carrier is available for delivery, and performance information. The servers 202 can process and/or store the received carrier information in database 216, as described in greater detail below.

The merchant devices 204a-n are computing devices operated by or otherwise associated with different merchants. Each merchant device can receive product orders from customers (e.g., customers 214a-n). The product orders can be received directly at the merchant devices 204a-n (e.g., in-person or telephone orders) or can be communicated to the merchant devices 204a-n via the network 212. For example, customers 214a-n can place product orders at customer computing devices (not shown), such as a mobile phone or personal computing device, using an electronic shopping cart associated with any sales channel through which the merchant sells its products. Purchase data may be sent by the electronic shopping cart to merchant devices 204a-n, as well as to other devices in the environment 200 (e.g., servers 202 and node devices 206a-n).

To fulfill received customer orders, the merchant devices 204a-n send requests for delivering inventory from warehouse nodes to customers. Those requests may be sent directly to the warehouse nodes, or may be coordinated through servers 202. In some embodiments, purchase data from a merchant device includes a list of items purchased, the quantities of items purchased, destinations to which the items are to be delivered, and a shipping speed. Using the purchase data, warehouse node information, and/or carrier information, warehouse nodes are selected that are capable of fulfilling the purchase. Once the fulfilling warehouse nodes have been determined, delivery instructions are sent to the warehouse node devices corresponding to the appropriate warehouse nodes. In response, the appropriate warehouse nodes can fulfill the purchases, and inventory information at the corresponding warehouse node devices 206a-n is updated accordingly. If the merchant coordinates fulfillment directly with a warehouse node, the merchant may also provide server 202 with information about the number and type of product sales associated with each warehouse node.

To stimulate the sale of products, a merchant may run advertising promotions associated with those products. The advertising promotions may be targeted at particular regions and customers, and may include one or more special incentives (e.g., discounts, free or reduced cost shipping, companion products, etc.) as part of the advertisements. The advertiser devices 210a-n are computing devices operated by or otherwise associated with different advertising partners. In some embodiments, the advertiser devices 210a-n communicate with merchant devices 204a-n and/or the servers 202 to initiate an advertising promotion on behalf of a merchant. Parameters of advertising promotions include the merchant's items to be promoted, the period of time during which the promotion is active, the geographic region covered by the promotion, and incentives (such as expedited and/or reduced-fee shipping options) offered during the promotion. Further parameters of advertising promotions include a total advertising spend for the promotion, as well as a maximum price per advertisement (e.g., a bid price). The advertiser devices 210a-n additionally communicate with servers 202 to manage (e.g., adjust or terminate) advertising promotions on behalf of a merchant. In some embodiments advertiser devices 210a-n and servers 202 communicate with each other to manage advertising promotions without communication with merchant devices 204a-n. Furthermore, the advertiser devices 210a-n additionally communicate (e.g., via network 212) through various advertising channels to allow advertisements to be displayed on customer computing devices (not shown).

As purchase orders are fulfilled by the selected warehouse nodes, the servers 202 can monitor inventory levels at each warehouse node. For example, node devices 206a-n may continuously or periodically update maintained inventory information as purchases are fulfilled from the corresponding warehouse nodes. Based on the monitored inventory levels, as well as received purchase data, the servers 202 can determine whether any advertising promotions associated with the purchased products should be adjusted. In some embodiments, the servers 202 receive information regarding the start of an advertising promotion, and the initial promotion parameters (e.g., the items being promoted, the regions in which the promotion is active, the promoted shipping speeds and shipping costs, etc.) from merchant devices 204a-n and/or advertiser devices 210a-n. If the servers 202 determine that adjusting an advertising promotion is necessary or beneficial, it can determine what parameters of the promotion (for example, offered shipping speeds) should be adjusted, and transmit information about the adjusted promotion to advertiser devices 210a-n. In some embodiments, the promotion adjustment process is performed without receiving instruction or other input from merchant devices 204a-n. In some embodiments, information regarding the adjusted promotions is transmitted to the merchant devices 204a-n, even when adjustments are made without input from the merchant devices. An additional description of how the servers adjust advertising promotions is provided below.

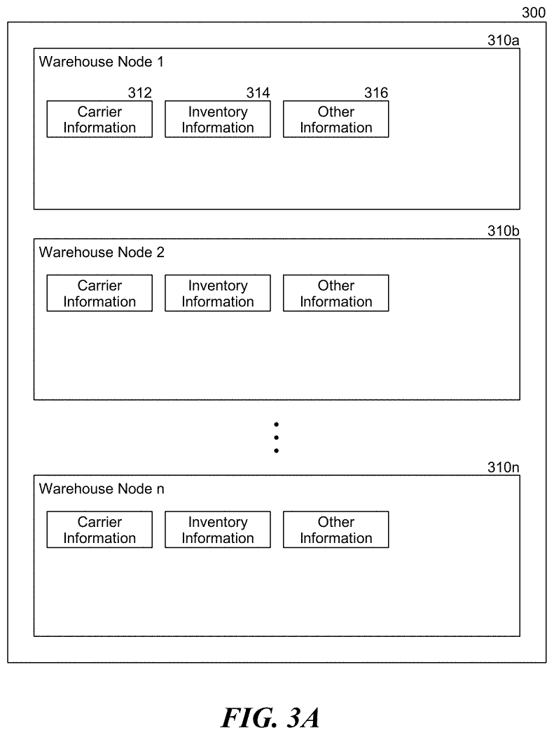

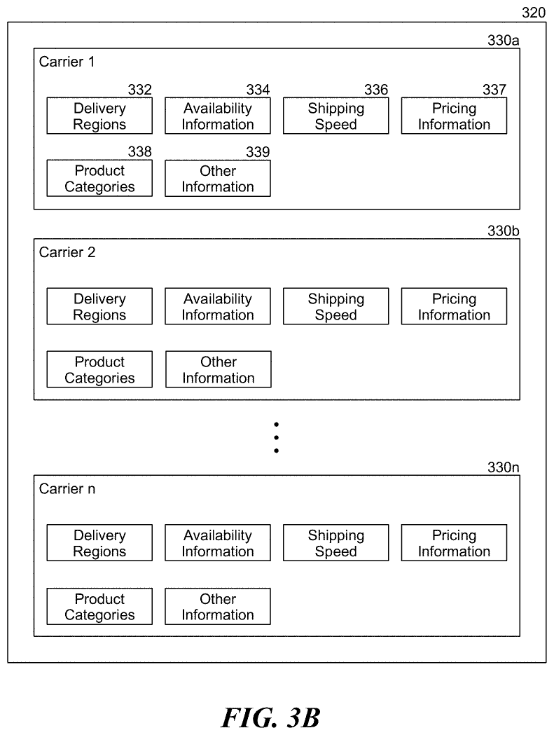

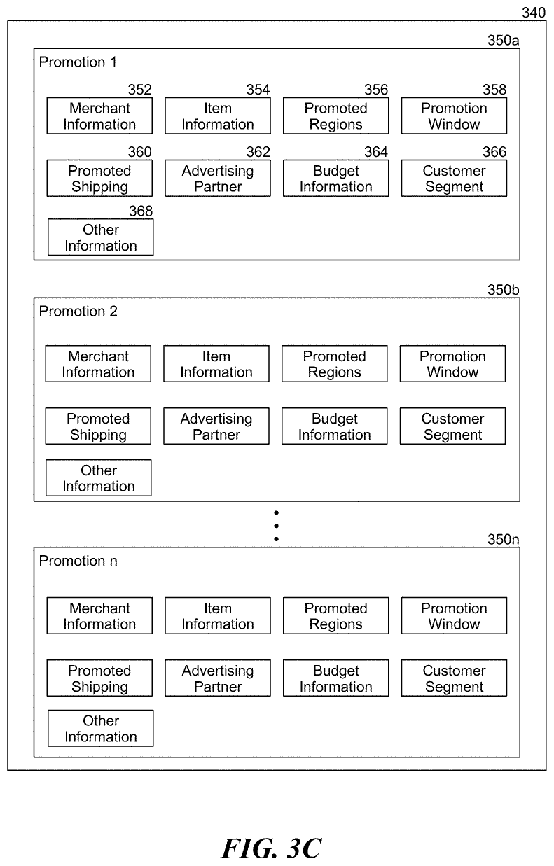

FIG. 3A is a schematic illustration of an exemplary data structure 300 for storing warehouse node information. The data structure 300 is generated and/or accessed by a promotion management system. For example, data structure 300 can be incorporated in the database 216 described with respect to FIG. 2. The data structure 300 includes a plurality of node data sets 310a-n. Each node data set stores information for a corresponding warehouse node, such as carrier information 312, inventory information 314, and/or other information 316. The data structure 300 can be used to store data for a very large number of warehouse nodes. In some embodiments, for example, the data structure 300 includes node data sets that represent, at least 500, at least 1000, or at least 5000 different warehouse nodes.

Carrier information 312 can include any information relevant to the carriers that deliver from the warehouse node, such as the names of the carriers, contact information, delivery regions, pick-up regions, shipping speed, pricing information, handling options, availability information, performance information, carrier restrictions (e.g., types of products or limitations on product dimensions), and the like. Additional examples of carrier information are described in greater detail below.

Inventory information 314 can include any information relevant to the inventory currently stored at the warehouse node, such as levels or amounts of goods (e.g., in pallets, number of inventory units), the merchant owning the inventory, location within the facility, start date of the storage period, expected end date of the storage period, special handling instructions, and the like.

Other information 316 can include any warehouse node information suitable for use with the embodiments described herein. Examples of other information include facility information (e.g., the location of the warehouse node, the storage capacity of the warehouse node, operating hours of the warehouse node, how late the warehouse node can process orders, logistics or restrictions of the warehouse node's loading capabilities, etc.), availability information, pricing information, and the like.

FIG. 3B is a schematic illustration of an exemplary data structure 320 for storing carrier information. The data structure 320 is generated and/or accessed by a promotion management system. For example, the data structure 320 can be incorporated in the database 216 described with respect to FIG. 2. The data structure 320 includes a plurality of carrier data sets 330a-n. Each carrier data set stores information for a corresponding carrier, such as delivery regions 332, availability information 334, shipping speed 336, pricing information 337, product categories 338, and other information 339. The information in the carrier data set can also include any information previously described with respect to carrier information 312 of FIG. 3A.

Delivery regions 332 can include any information relevant to the locations where the carrier can deliver shipments, such as addresses, area codes, maps, GPS coordinates, other geographic descriptors, delivery restrictions (e.g., only to business or residential addresses), and the like.

Availability information 334 can include any information relevant to the availability of the carrier to deliver shipments, such as time frames (e.g., days, weeks, months) when the carrier is available to pick up from a pick-up region, time frames when the carrier is available to deliver to a delivery region, time frames when shipping speed options are available, shipment parameters (e.g., maximum dimensions, weight), and the like.

Shipping speed 336 can include any information relevant to the time frames in which shipments are to be delivered to customers, such as types of shipping speeds available (e.g., same-day delivery, next-day delivery, two-day delivery, three to five business-days delivery, standard, express, priority), pick-up regions where shipping speed options are available, delivery regions where shipping speed options are available, delivery distances where shipping speed options are available, seasonal information about when shipping speeds are expected to be slower or faster (e.g., holidays), and the like.

Pricing information 337 can include any information relevant to prices for delivering shipments, such as prices per unit (e.g., per pallet), prices per weight (e.g., per pound), prices based on shipping speed, prices based on delivery region, prices based on pick-up region, prices based on shipping distance, flat-rate shipping prices, prices for special handling (e.g., for refrigeration, fragile goods, large goods), prices for add-ons or other services, available discounts (e.g., for high-volume shippers), and the like.

Product categories 338 can include any information relevant to the type of products the carrier can deliver, such as whether the carrier can deliver food, whether the carrier can deliver alcohol, whether there are size or weight limitations on the products the carrier can deliver, and the like.

Other information 339 can include any other carrier information suitable for use with the embodiments described herein.

FIG. 3C is a schematic illustration of an exemplary data structure 340 for storing promotion information. The data structure 340 is generated and/or accessed by a promotion management system. For example, the data structure 340 can be incorporated in the database 216 described with respect to FIG. 2. The data structure 340 includes a plurality of promotion data sets 350a-n. Each promotion data set stores information for a corresponding advertising promotion, such as merchant information 352, item information 354, promoted regions 356, promotion window 358, promoted shipping 360, advertising partner 362, budget information 364, customer segment 366, and other information 368.

Merchant information 352 can include any information relevant to the merchant associated with the advertising promotion, such as the merchant's name, contact information for the merchant, a merchant identifier, and the like.

Item information 354 can include any information relevant to the items being promoted by the merchant through the advertising promotion. Item information can include item descriptions, item identifiers, the number of items that may be sold under the promotion, and the like.

Promoted regions 356 can include any information relevant to the geographic region in which the advertising promotion is active. For example, a promotion may only target or be available to customers purchasing from a particular region. As a further example, promoted items, or promotion benefits (e.g., expedited shipping), may only be available for delivery to a particular region. Promoted regions can be characterized by area codes, map boundaries, GPS coordinates, cities, states, and the like.

Promotion window 358 can include any information relevant to the period of time during which the advertising promotion is active, such as promotion start and end dates, a calendared event or holiday around which the promotion is active (e.g., a sports event, Christmas, etc.), a non-calendared event around which the promotion is active (e.g., during a weather condition or state of emergency occurring within the promotion region), and the like.

Promoted shipping 360 can include any information relevant to shipment options advertised as part of the promotion, such as shipping speeds, shipping costs, special handling instructions, and the like.

Advertising partner 362 can include any information relevant to the advertising partners through which advertisements are served as part of the promotion, and can include information such as partner name, partner contact information, partner identifier, advertising channels through which the advertising partner will serve promoted advertisements, and the like.

Budget information 364 can include any information relevant to the budget afforded to the advertising promotion, such as the maximum bid price for each advertisement or impression, the total spend for the advertising campaign, and the like.

Customer segment 366 can include any information relevant to the segment of customers eligible for or to be targeted by the advertising promotion. For example, customer segment data can indicate that only new customers are eligible for an advertising promotion, that only customers with a certain type of purchasing history or status with the merchant are eligible for the promotion, etc.

Other information 368 can include any other promotion information suitable for use with the embodiments described herein.

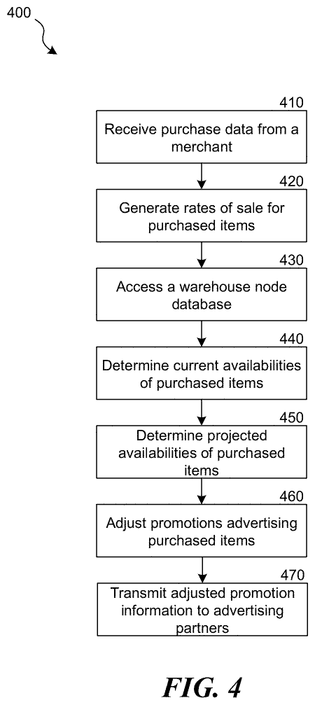

FIG. 4 is a flow diagram illustrating an exemplary process 400 implemented by a promotion management system used for initiating, modifying (increasing or decreasing), or terminating advertising promotions used to promote item sales on behalf of a merchant. The process 400 can be performed by one or more computing devices of the system (e.g., servers 202 of FIG. 2). In some embodiments, the process 400 can be performed upon the occurrence of a triggering event (e.g., when a purchase is made and new purchase data is received, when warehouse inventory information has been updated, etc.). In some embodiments, the process 400 can be performed periodically (e.g., hourly, daily, etc.) to evaluate whether current product inventory and related data indicate an opportunity to initiate or adjust an advertising promotion.

The process 400 begins at block 410, where the system receives item purchase data. In some embodiments, the purchase data is received directly from the selling merchant. As described herein, the purchase data can be transmitted from a merchant device (e.g., devices 204a-n of FIG. 2) to a computing device of the system (e.g., servers 202 and/or node devices 206a-n of FIG. 2). The purchase data describes a purchase made, by a customer, of one or more items offered for sale by the merchant. The purchase data can include the selling merchant and a list of the one or more items purchased by the customer, some of which may be promoted by the merchant through an advertising campaign. The purchase data can also include a quantity for each of the purchased items, a timestamp of when the purchase was made, and a delivery region to which the purchased items are to be delivered.

In some embodiments, the purchase data is received from a third-party shopping cart partner on behalf of the merchant. For example, a merchant's website or application may use an electronic shopping cart feature provided by the shopping cart partner, which may provide functionality such as managing a digital storefront with shopping cart, validating address and payment information during purchases, transmitting purchase information on behalf of the merchant, etc. Representative third-party shopping cart partners include WooCommerce, Skava, and Kibo, though it will be appreciated that merchants may utilize other platforms that provide similar services.

At block 420, the system generates rates of sales for the purchased items, which characterize the quantity of units sold over a selected amount of elapsed time (e.g., X items per Y hours). To generate a rate of sale for an item, in some embodiments the system uses the received purchase data as well as historical purchase data for the item over a selected period of time. Using the received purchase data and historical purchase data, the system can extrapolate the rate at which the item typically sells. For example, if in the past hour the system has received purchases for 10 units of an item, and in the prior hour the system had received purchases for 20 units of the item, then the system would generate a rate of sale of 15 units of the item per hour. The historical purchase data may be maintained in a table that tracks sales of products on a per-unit period of time basis. For example, the following table includes sales data on an hourly basis for two items, A and B:

| | Hour 1 | Hour 2 | Hour 3 | Hour 4 | . . . | Hour 24 |
|---|---|---|---|---|---|---|
| Item A | 0 | 5 | 3 | 1 | . . . | 3 |
| Item B | 0 | 2 | 0 | 8 | . . . | 0 |

In some embodiments, the system uses various metrics, instead of or in addition to received purchase data and historical purchase data, to generate the sales rate for an item. The system can receive the metric data from the merchant or shopping cart partner, for example as part of the purchase data. For example, the system can generate the sales rate for an item based on the cart conversion rate associated with the item (e.g., the higher likelihood that an item placed in a shopping cart will proceed to checkout, the higher the sales rate for the item). As a further example, the system can use characteristics of purchases of an item (e.g., what times of day the item is typically purchased; in what ZIP codes, cities, states, or other regions the item is typically purchased) to generate a sales rate. As a still further example, the system can use information about purchases made together (e.g., an order that includes item X often includes item Y) to generate a sales rate for an item based on observed purchased for a paired item.

The system can generate rates of sale for each item represented in the purchase data. That is, if the purchase data reflects the purchase of items A and B, the system can generate individual rates of sale for items A and B. The system can additionally generate rates of sale for each item-region pair represented in the purchase data. That is, if the purchase data reflects the purchase of two units of item A, one of which is to be delivered to region 1, and the other of which is to be delivered to region 2, the system can generate a rate of sale for item A in region 1, and a rate of sale for item A in region 2.

In some embodiments, the system only uses historical purchase data from the region to which the purchased items (in the received purchase data) are to be delivered. In some embodiments, the system only uses historical purchase data corresponding to purchases of a sufficient recency (e.g., within the past day, the past week, etc.) or corresponding to purchases made since a threshold event occurred (e.g., since an advertising campaign promoting an item has started).

At block 430, the system accesses a warehouse node database that stores a plurality of node data sets representing a plurality of warehouse nodes. The database can be or include data structure 300 of FIG. 3A, and the node data sets can be identical or generally similar to node data sets 310a-n. Each node data set is associated with a corresponding warehouse node and can include carrier information, inventory information, and/or other information for the warehouse node, as described herein.

In some embodiments, the database also stores a plurality of carrier data sets representing a plurality of carriers. The carrier data sets can be included within the node data sets (e.g., as part of the carrier information) or can be provided as a separate data structure. For example, the database can also include data structure 320 of FIG. 3B, and the carrier data sets can be identical or generally similar to carrier data sets 330a-n. Each carrier data set can be associated with a corresponding carrier and can include delivery regions, shipping speed, pricing information, availability information, and/or other information for the carrier, as described herein.

At block 440, the system determines the current availabilities of each of the purchased items in an identified set of warehouse nodes, based on the node data sets and the purchase data. In some embodiments, for each of the purchased items represented in the purchase data, the system identifies the one or more warehouse nodes that have at least one of the purchased item in inventory. In some embodiments the identification of the warehouse nodes is further limited to only those warehouse nodes that are capable of fulfilling the purchased item to the region associated with the purchase data. The system then generates a current availability for each of the purchased items based on the merchant's inventory of that item in the set of identified warehouse nodes, for example by adding the inventory at the different nodes. If the purchase data indicates that the same item was purchased in multiple units, some of which are associated with different regions (e.g., one unit of item A is to be delivered to region 1, and one unit of item A is to be delivered to region 2), then in some embodiments the system determines a current availability for the item in each of the regions. It will be appreciated that the determination of current availability performed by the system at the block 440 is intended to capture data relevant to the ability to fulfill future orders on behalf of a merchant (which as described herein, is useful for managing a corresponding advertising promotion).

At block 450, the system determines the projected availabilities of each of the purchased items, based on the rates of sale and current availabilities of the purchased items. To determine the projected availability for a purchased item in a region, the system evaluates the corresponding rate of sale for the item in the region as well the current availability for the item in the region (as determined at blocks 420 and 440, respectively), and projects how item inventory will drop as sales continue. For example, the system can extrapolate from the rate of sale to predict how much inventory will remain after an hour, after a day, after a week, or other periods of time. As a further example, the system can predict when inventory will run out (i.e., hit zero), or hit some other threshold, such as 10% of the inventory as compared to a last restocking of inventory. As a still further example, the system can predict when inventory will increase due to inbound shipments to the warehouse of the items (as indicated, for example, by the warehouse node data).

In some embodiments, the system projects the availabilities of purchased items based on other information in addition to or instead of based on sales rates. For example, the system can use historical data associated with an item (e.g., advertising impressions, historical demand, etc.) to predict the sell-through rate for the item. As a further example, the system can use the cycle time of an item (e.g., the time it takes to manufacture an item) to predict availabilities based on how long it will take to replenish stock of that item.

At block 460, the system adjusts advertising promotions that are used to promote the purchased items. For example, the system can adjust various parameters of the promotion, in anticipation of running out of inventory of the promoted items, to generate less encouragement to customers to purchase the promoted items (i.e., to decrease the rate of sale of the promoted item). Such an adjustment can be used to slow or end a promotion before inventory gets low enough such that purchases cannot be fulfilled. As a further example, the system can adjust the various parameters of the promotion to further increase customer encouragement (i.e., to increase the rate of sale of the promoted item) if there is greater than anticipated inventory and/or there has been an unanticipated decrease in the rate of sale.

The system can adjust promotion parameters related to shipping, such as the advertised delivery speed, advertised delivery date, or advertised shipping cost. For example, a promotion that had previously advertised free one-day shipping may be adjusted to advertise free three-day shipping as inventory of the promoted item diminishes, due to less availability of the item in a region, the projected need to fulfill purchases of the item from warehouse nodes that are further away from the customer or have access to slower carriers, etc. As a further example, a promotion may be adjusted to no longer advertise same-evening delivery if no warehouse nodes and associated carriers offer evening services.

The system can additionally adjust promotion parameters related to what items are promoted and in which regions. For example, a promotion advertising multiple items (e.g., an umbrella in red and an umbrella in black) can be adjusted to no longer promote certain items as inventory of those items decreases (e.g., continue to promote the umbrella in red but no longer promote the umbrella in black). As a further example, the system can adjust a promotion that was promoting an item in multiple regions to instead promote the item in other regions (e.g., a subset of the previously promoted regions, additional promoted regions, etc.) based on changes of the projected availability of the item in the different regions.

The system can also adjust promotion parameters related to advertising budgets. For example, the system can adjust the maximum amount to be paid for each advertising impression (i.e., price per impression bid). As a further example, the system can adjust the total amount of advertising budget for the promotion. As a still further example, the system can end an advertising promotion entirely.

To determine how to adjust promotion parameters, the system may utilize warehouse node information, including warehouse node information corresponding to the warehouse nodes identified at the block 440 (i.e., corresponding to warehouse nodes with relevant merchant inventory that can be delivered to regions of interest). The system may additionally utilize the carrier information for the carriers that deliver from those warehouse nodes. Using the warehouse node information and carrier information, the system can, for example, evaluate the projected ability to deliver promoted items without different regions and adjust promotion parameters accordingly. For example, in some embodiments the system may implement the following methodology to automatically adjust advertising promotions:

| Item Inventory Level Across One or | |
|---|---|
| Multiple Warehouse Nodes in Region | Advertising Campaign in |
| Targeted by Advertising Campaign | Associated Region |
| Inventory >50% of initial stock level | Advertisement + free shipping + |
| | 1 day delivery |
| Inventory between 15-50% of initial | Advertisement + free shipping |
| stock level | |
| Inventory between 5-15% of initial | Advertisement |
| stock level | |
| Inventory between 0-5% of initial | Halt advertising campaign |
| stock level | |

Notably, as the number of warehouse nodes grows, the system is able to target regions for hyper-local advertising campaigns. For example, if deliveries to a zip code can be made from any of four warehouse nodes, inventory associated with those four warehouse nodes can be summed by the system to determine item inventory levels associated with that zip code. An advertising promotion associated only with that zip code may then be adjusted by the system based on the item inventory level within those four warehouse nodes.

In some embodiments, the system may implement the following methodology to automatically adjust advertising promotions:

| Time Until Inventory Needs | |
|---|---|
| Replenishment Across One or Multiple | |
| Warehouse Nodes in Region Targeted | Advertising Campaign in |
| by Advertising Campaign | Associated Region |
| 1-2 months | Advertisement + free shipping + |
| | 1 day delivery |
| 2-4 weeks | Advertisement + free shipping |
| 1-2 weeks | Advertisement |
| 1-4 days | Halt advertising campaign |

That is, the system computes the rate of inventory sales from one or more warehouses associated with a particular delivery region (e.g., a zip code). Based on current inventory levels and sales rate within that region, the system projects the length of time that inventory remains within the associated warehouse nodes. As the time at which replenishment must occur approaches, the system may modify or terminate an advertising campaign associated with the inventory item. Modifying or terminating the advertising campaign has the effect of slowing the sales rate, thereby allowing appropriate inventory replenishment to occur and minimizing the likelihood that a customer will receive a “product unavailable” condition when attempting to purchase the item.

In some embodiments, instead of or in addition to adjusting an advertising campaign based on item inventory levels, the system can determine a target price for a product based on various factors (e.g., inventory level, cost to store the good at a warehouse, cost to transport the good from a warehouse, etc.), and adjust an advertising promotion accordingly. For example, given a cost to store each unit of a product at a warehouse, the cost to transport each unit of the product from the warehouse to a destination, the cost of each unit of the good, and any additional fulfillment costs, the system can generate an optimal total price of the product for a sales target. In some embodiments, the total price of the product includes the sales price of the product and/or the shipping price of the product. In some embodiments, the sales target represents the available inventory of the product at a corresponding warehouse. In some embodiments, one or more costs (e.g., storage costs and fulfillment costs) vary with the length of time a unit of the product is stored in the warehouse. In some embodiments the length of time a unit of the product is predicted to be stored at a warehouse changes with the total price of the product (e.g., based on historical conversion rates). In other words, the system can identify opportunities to set the price for a product based on factors of the warehouses and carriers that store and transport the product, respectively, and can adjust an advertising promotion accordingly. An example minimization function used by the system may look like the following, where p represents the total price:

$${\sum }_{p = minimum price}^{p = maximum price} p - {C}_{storage} ( time stored ) - {C}_{transport} ( average distance shipped ) - {C}_{product} - {C}_{fulfillment} ( units sold )$$

Where C_{storage} equals the cost of storage per unit of time (e.g., per month), Cₜᵣₐₙₛₚₒᵣₜ equals the average cost of transport for the item within a region shipped, C product equals the cost of the product, and C_{fulfillment} equals any additional fulfillment costs.

At block 470, the system transmits information regarding the adjusted advertising promotion, such as the promotion parameters, to any advertising partners that serve advertisements on behalf of the merchant as part of the promotion. For example, the merchant may place advertisements on Internet search websites (e.g., Google, Bing, etc.), social media websites (e.g., Facebook, Instagram, etc.), and other websites or Internet channels through which advertisements are served. In response, the advertising partners update the advertisements that are served to customers accordingly. In some embodiments, the system can transmit the information on the adjusted parameters to the advertising partners without notifying, or the intervention from, the merchant.

The process 400 can be implemented in a number of different ways. For example, some of the steps can be combined with each other or with steps of other processes described herein. In some embodiments, the process 400 is repeated by the promotion management system to process multiple purchases received from multiple different merchants and/or from the same merchant. In some embodiments, the process 400 is repeated by the promotion management system to evaluate multiple different warehouse nodes and to adjust advertising promotions served within the delivery region of each warehouse node. In other words, the promotion management system can utilize the process 400 to establish or adjust advertising promotions tailored to different regions. Some or all of the steps of the process 400 can be performed automatically by the system (e.g., by servers 202 of FIG. 2) without input from a human operator. The management of different advertising promotions in response to changes in inventory is difficult to perform manually because of the large numbers of warehouse nodes involved, the multifactorial analysis to determine the sort of advertised promises that can be reliably met when utilizing different warehouse nodes and carriers, and the complexity of quickly adjusting to changes in sales rates and inventory.

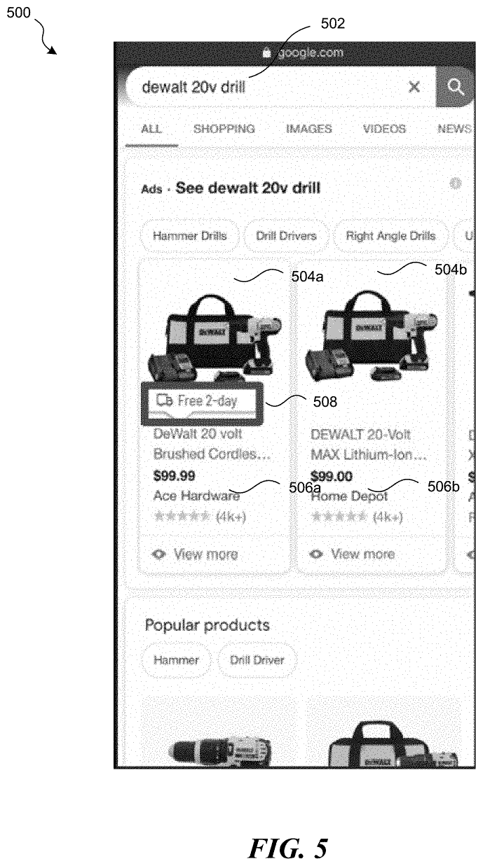

FIG. 5 is a schematic illustration of an exemplary search result 500, with advertisements, for a promoted item. The search result can be displayed on a computing device operated by or otherwise associated with an end-user or customer (e.g., customers 214a-n of FIG. 2). Based on the end-user's search for item 502, an advertising partner (such as a search provider) displays advertisements 504a and 504b, which advertise purchasing the item from merchants 506a and 506b, respectively. The different advertisements served on behalf of the different merchants 506a-n, however, can offer different incentives as part of an advertising promotion managed by the promotion management system. For example, as illustrated, the advertisement 504a on behalf of merchant 506a offers the incentive 508 of free two-day shipping. In contrast, no such incentive is offered with advertisement 504b. The advertisement 504a may be initially utilized by a merchant but, as inventory levels drop and the ability to fulfill demand becomes more difficult, the system may adjust the advertising campaign to remove the incentive associated with the item and instead display advertisement 504b.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combination or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

Although certain embodiments herein are described in the context of “warehouse nodes,” it will be appreciated that the system and methods herein are applicable to many different kinds of facilities for storing inventory and are not limited to commercial warehouses. Additionally, a “carrier” as described herein includes any provider of services for transportation of inventory by ground, air, water, or combinations thereof. As described herein, a “merchant” can be a vendor, retailer, reseller, or any other individual or entity providing inventory for sale.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system and method may vary considerably in their specific implementations, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

1. A computer-implemented method for adjusting a digital promotion responsive to item availability projections, the method comprising:
receiving purchase data from an electronic shopping cart associated with a merchant, the purchase data comprising an item, an item quantity, and a delivery region,
wherein the purchase data further includes metric data comprising a conversion rate for the item, the conversion rate representing an estimated likelihood that the item, when placed in the electronic shopping cart, will be purchased;
generating a current rate of sale for the item based on the purchase data,
wherein the current rate of sale is generated using the conversion rate for the item;
accessing a database storing a plurality of node data sets, each node data set being associated with a warehouse node, wherein each node data set includes inventory information and carrier information for the warehouse node;
using the inventory information and the rate of sale to compute a projected availability of the item in the delivery region during a time period; and
automatically adjusting, based on the projected availability, a digital promotion advertising the item in the delivery region by performing at least one of the following actions:
terminating the digital promotion,
adjusting a parameter of the digital promotion related to shipping,
adjusting a region where the item is advertised, or
adjusting a parameter of the digital promotion related to an advertising budget.

2. The method of claim 1, wherein computing the projected availability of the item in the delivery region comprises:
identifying, based on carrier information, warehouse nodes associated with at least one carrier that ships from the warehouse node to the delivery region; and
calculating, based on the inventory information, a current availability of the item for the merchant from the identified warehouse nodes,
wherein the projected availability is further computed using the current availability of the item for the merchant from the identified warehouse nodes.

3. The method of claim 2, wherein the carrier information comprises shipping speeds for each of the carriers that ship from the warehouse node, and wherein the parameter of the digital promotion related to shipping comprises an advertised shipping speed, an advertised delivery estimate, or an advertised shipping price.

4. The method of claim 1, further comprising transmitting information about the adjusted digital promotion to a digital advertising provider.

5. The method of claim 1, wherein the adjustment of the digital promotion is performed without transmitting a notification to the merchant.

6. The method of claim 1, further comprising updating the inventory information of a node data set based on the received purchase data.

7. The method of claim 1, further comprising receiving second shopping data from a second electronic shopping cart associated with the merchant, the purchase data comprising the item and a second item quantity.

8. The method of claim 1, wherein adjusting the digital promotion comprises adjusting a per-advertisement bid price, a total campaign spend, an advertising region, an advertised shipping speed, an advertised delivery estimate, or an advertised shipping price.

9. The method of claim 1, the method further comprising:
obtaining, from the node data sets, cost data for the associated warehouse nodes in the delivery region;
determining, based on the cost data and projected availability, a total price for the item; and
wherein the digital promotion is adjusted based on the total price.

10. The method of claim 9, wherein the cost data comprises the cost to store the item at the associated warehouse node, or the cost to ship the item from the associated warehouse node to a destination in the delivery region.

11. A non-transitory computer-readable medium carrying instruction configured to cause one or more processors to perform operations for adjusting a digital promotion responsive to item availability projections, the operations comprising:
receiving purchase data from an electronic shopping cart associated with a merchant, the purchase data comprising an item, an item quantity, and a delivery region,
wherein the purchase data further includes metric data comprising a conversion rate for the item, the conversion rate representing an estimated likelihood that the item, when placed in the electronic shopping cart, will be purchased;
generating a current rate of sale for the item based on the purchase data,
wherein the current rate of sale is generated using the conversion rate for the item;
accessing a database storing a plurality of node data sets, each node data set being associated with a warehouse node, wherein each node data set includes inventory information and carrier information for the warehouse node;
using the inventory information and the rate of sale to compute a projected availability of the item in the delivery region during a time period; and
automatically adjusting, based on the projected availability, a digital promotion advertising the item in the delivery region by performing at least one of the following actions:
terminating the digital promotion,
adjusting a parameter of the digital promotion related to shipping,
adjusting a region where the item is advertised, or
adjusting a parameter of the digital promotion related to an advertising budget.

12. The non-transitory computer-readable medium of claim 11, wherein computing the projected availability of the item in the delivery region comprises:
identifying, based on carrier information, warehouse nodes associated with at least one carrier that ships from the warehouse node to the delivery region; and
calculating, based on the inventory information, a current availability of the item for the merchant from the identified warehouse nodes,
wherein the projected availability is further computed using the current availability of the item for the merchant from the identified warehouse nodes.

13. The non-transitory computer-readable medium of claim 12, wherein the carrier information comprises shipping speeds for each of the carriers that ship from the warehouse node, and wherein the parameter of the digital promotion related to shipping comprises an advertised shipping speed, an advertised delivery estimate, or an advertised shipping price.

14. The non-transitory computer-readable medium of claim 11, wherein the operations further comprise transmitting information about the adjusted digital promotion to a digital advertising provider.

15. The non-transitory computer-readable medium of claim 11, wherein the adjustment of the digital promotion is performed without transmitting a notification to the merchant.

16. The non-transitory computer-readable medium of claim 11, wherein the operations further comprise updating the inventory information of a node data set based on the received purchase data.

17. The non-transitory computer-readable medium of claim 11, wherein the operations further comprise receiving second shopping data from a second electronic shopping cart associated with the merchant, the purchase data comprising the item and a second item quantity.

18. The non-transitory computer-readable medium of claim 11, wherein adjusting the digital promotion comprises adjusting a per-advertisement bid price, a total campaign spend, an advertising region, an advertised shipping speed, an advertised delivery estimate, or an advertised shipping price.

19. The non-transitory computer-readable medium of claim 11, wherein the operations further comprise:
obtaining, from the node data sets, cost data for the associated warehouse nodes in the delivery region;
determining, based on the cost data and projected availability, a total price for the item; and
wherein the digital promotion is adjusted based on the total price.

20. The non-transitory computer-readable medium of claim 19, wherein the cost data comprises the cost to store the item at the associated warehouse node, or the cost to ship the item from the associated warehouse node to a destination in the delivery region.

21. The method of claim 1, wherein adjusting the region where the item is advertised comprises:
identifying at least one other region in which to promote the item,
wherein the at least one other region comprises a subset of regions in which the item was previously promoted or an additional promoted region; and
adjusting the digital promotion to promote the item in the identified at least one other region.
